(19) United States
(12) Patent Application Publication
(10) Pub. No.: US 2023/0196310 A1
(43) Pub. Date: Jun. 22, 2023

(54) METHODS AND SYSTEM FOR CROSS-BLOCKCHAIN COLLATERALIZATION

(71) Applicants: Wellfield Technology IR Limited, Dublin (IE); THE IP LAW FIRM OF GUY LEVI, LLC, Wyckoff, NJ (US)

(72) Inventor: Levy Cohen, Tel Aviv (IL)

(21) Appl. No.: 17/908,838

(22) PCT Filed: May 7, 2022
(86) PCT No.: PCT/US2022/028228

§ 371 Date: Sep. 1, 2022

Related U.S. Application Data
(60) Provisional application No. 63/185,416, filed on May 7, 2021.

(51) Int. Cl. G06Q 20/06; G06Q 20/36; H04L 67/104

(52) U.S. Cl. CPC G06Q 20/065; G06Q 20/36; H04L 67/104

(57) ABSTRACT

The disclosure relates to systems, methods and computer-readable media for cross blockchain collateralization. Specifically, the disclosure relates to systems, methods and computer-readable media for providing cryptocurrency liquidity for transactions in one blockchain with collateral pegged to cryptocurrency on another blockchain using a stablecoin token.

### BACKGROUND

The disclosure is directed to systems, methods and computer-readable media for cross blockchain collateralization. Specifically, the disclosure is directed to systems, methods and computer-readable media for providing cryptocurrency liquidity for transactions in one blockchain with collateral cryptocurrency on another blockchain.

Blockchain technology has been developed to provide decentralized, secure, and immutable storage of data for transactions among users. Some common characteristics of this technology involve a mechanism for settling a transaction via a decentralized computational consensus which is maintained on an electric ledger. Accordingly, an electronic representation of value, such as a bitcoin, may be transmitted from a party A to a party B, such that party B is assured that it has obtained that bitcoin and party A cannot claw it back or send it to a different party, with a network of 3^{rd} party computers validating the transaction. The validated transaction is recorded on an electronic ledger, or blockchain.

Subsequent to bitcoin, blockchain technology which allowed users to program their own applications advanced and are processed via a blockchain, e.g., decentralized applications (DAPPS), or smart contract. Such DAPPS can result in the creation of additional representations of value often called tokens. One such project includes Ethereum, which employed smart contracts and permitted the issuance of tokens, capable of being exchanged and validated on the ethereum blockchain.

Incentives for processing of blockchain transactions can be done by payment of an underlying value of a blockchain system. For instance, for processing the transfer of a bitcoin transaction, an amount of bitcoin is paid for by a party to the party processing the transaction. Similarly, a transfer of Ethereum, or tokens, between parties is paid for by ether (ETH) to the processing party. Typically, the primary underlying currency that is often referred to as a coin, and secondary representations of value that are issued based on DAPPS are called tokens.

With increased exchange in cryptocurrencies, between individuals using electronic wallets, as well as large public exchanges, broad fluctuations in market pricing of such blockchain-based coins and tokens occurred. In order to avoid such wild fluctuations or to avoid having to exchange to government fiat, stablecoins were introduced.

Stablecoins are digital representations of value processed on a blockchain which are usually pegged to a government fiat or some predetermined value. For example, one of the first stablecoins is a cryptocurrency known as Tether. Tether was issued by the Bitfinex exchange with each Tether purportedly backed by a real USD, such that one Tether equals one USD.

In addition to real world asset backed stablecoins, there are two additional stablecoin types. The first is crypto-currency backed stablecoin whereby the underlying value of the reference is given usually by a basket of other major cryptocurrencies (like Bitcoin, Ethereum or Ripple) owned either by the token holder or the issuer. The second type is Non-Collateralized and in this category of stablecoin each unit does not directly represent another asset and its value, and the stability characteristics are given by a different mechanism, for example a complex “seigniorage” algorithm or other processes not involving an immediate backing of a commodity, a currency or a cryptocurrency.

Globally as of 2020, there are about 1.7 billion adults remain unbanked— without an account at a financial institution or through a mobile money provider. Moreover issuing a cryptocurrency backed stablecoin backed by a basket of cryptocurrencies on blockchains involving the same cryptocurrencies in the basket will create distortion.

These and other shortcomings of the current state of affairs are addressed by the following disclosure, figures and claims.

### SUMMARY

Disclosed, in various embodiments, are systems, methods and computer-readable media for providing cryptocurrency liquidity for transactions in one blockchain with collateral cryptocurrency on another blockchain.

In an embodiment provided herein is a computerized method for collateralizing cryptocurrency in a first blockchain of a peer-to-peer (P2P) distributed network, the method comprising: a first user via a first network node - depositing, with a first crypto wallet onto a predetermined address in the first blockchain, a predetermined value of a first cryptocurrency corresponding to the value of a second cryptocurrency stored in a second crypto wallet on a second blockchain; minting, at the first blockchain, a cryptocurrency stable token; and preserving a reserve value of the first cryptocurrency to equate the value of the second cryptocurrency and the minted stable token on the first blockchain.

These and other features of the systems, methods and computer-readable media for providing cryptocurrency liquidity for transactions in one blockchain with collateral cryptocurrency on another blockchain, will become apparent from the following detailed description when read in conjunction with the figures and examples, which are exemplary, not limiting.

### BRIEF DESCRIPTION OF THE FIGURES

NA.

### DETAILED DESCRIPTION

Provided herein are embodiments of systems, methods and computer-readable media for providing cryptocurrency liquidity for transactions in one blockchain with collateral cryptocurrency on another blockchain.

Accordingly and in an exemplary implementation, provided herein is a computerized method for collateralizing (in other words, using a valuable asset, namely the cryptocurrency in the pirst P2P netweork) cryptocurrency in a first blockchain of a peer-to-peer distributed network, for the purpose of providing cryptocurrency liquidity for transactions performed on a second blockchain of a peer-to-peer distributed network, the method comprising: a first user via a first network node -depositing, with a first crypto wallet onto a predetermined address in the first blockchain, a predetermined value of a first cryptocurrency corresponding to the value of a second cryptocurrency stored in a second crypto wallet on a second blockchain; minting, at the first blockchain, a cryptocurrency stable token; and preserving a reserve value of the first cryptocurrency to equate the value of the second cryptocurrency and the minted stable token on the first blockchain.

In the context of the disclosure, the term “user” is represented by any ERC-20 enabled Ethereum wallet that can purchase the cryptocurrency stable tokens directly from the service (DAPP). Note that the cryptocurrency stable token, like any ERC-20 token, is transferrable and exchangeable on any exchange that supports it and also in a peer-to-peer (P2P) manner. A P2P transaction of cryptocurrency stable token (e.g., StableBTC) costs a small (gas) fee in addition to the transaction fee on the blockchain where the cryptocurrency stable token is issued or minted. It is noted, that the system is operable regardless of whether the first P2P network uses a “proof of work” to determine a new block, or a “proof of stake”.

Furthermore, in the context of the disclosure, the term “node” represents any communicating element of a wireless or wired communication infrastructure, including Bluetooth, WiFi, cellular (e.g., LTE, 4G, 5G, etc.), servers and data-center systems, backbone and access routers, cloud computing nodes, and network interface cards (NIC) for vehicular, industrial, satellite, and computer networks. In particular, nodes can be implemented within various consumer electronic devices such as personal computers, computer products, laptops, phones, tablets, etc. The methods described herein are particularly attractive for mass-produced small-footprint devices due to the sensitivity of such devices to cost, power consumption, and complexity. Such devices include devices used in sensor systems, home networks, Internet of Things (IoT) networks, embedded systems, mesh networks, mobile ad-hoc networks (MANETs), mobile systems, cellular networks, small form factor (SFF) systems, and any device requiring low power consumption, using low-cost transceiver microchips, or having low computational capability. Thus in the present disclosure, the term “node” refers to a base station, a mobile terminal, a personal computer, or similar electronic devices capable of processing data, where these devices are capable of being networked and communicate with each other.

Furthermore, anyone can become a liquidity provider (LP, and thusly gain some revenues) upon installing the LP software, lock a first cryptocurrency (e.g., Bitcoin BTC) in a self-custody and deposit a second cryptocurrency (e.g., ether (ETH), Dogecoin) in a value of lxx% Bitcoin (see collateral management). It is noted that the same LP may add multiple amounts and values of the first cryptocurrency to the system. Similarly, anyone can become a “watcher” (referring to anyone employing a computer protocol configured to monitor and track current or historic events that occur on the first (e.g., Ethereum) blockchain, or validator (referring to anyone who continuously calculates and monitors the linkage between originating and subsequent blocks on the blockchain), and by which gain some revenues for their effort upon installing the Watcher software. The watcher can be one or more humans, applications, services, protocols, or other entities that monitor or wish to consume presence information (PI) associated with presentities (referring to any entity that have PI). When the watcher is an application or a service, the application or service might be wholly or partially resident on the DAPP. Furthermore, A watcher with the same identifier as a presentity is assumed to be under the control of the same principal.

As indicated, the cryptocurrency stable token (e.g., StableBTC), is minted on the first (e.g., Ethereum) blockchain. Accordingly and in an exemplary implementation, whenever an LP adds a first cryptocurrency (e.g., Bitcoin) to the system, the system mints a new cryptocurrency stable token (e.g., StableBTC) and whenever it removes the first cryptocurrency (e.g., Bitcoin) the system burns (removes) a cryptocurrency stable token. Specifically: in the context of the disclosure, Minting refers to when an LP deposits a second cryptocurrency (e.g., ETH) as collateral and provides proof of holding one first cryptocurrency (e.g., Bitcoin) in the user’s own first cryptocurrency (e.g., Bitcoin) wallet, one cryptocurrency stable token (e.g., StableBTC token) is minted and released to its cryptocurrency stable token (e.g., StableBTC token) wallet (on the first cryptocurrency blockchain (e.g., Ethereume blockchain)).

In the context of the disclosure, the term “Burning” means when an LP wants to exit the service (in other words, cease being LP), the user sends cryptocurrency stable token (e.g., StableBTC token) back to the service (in other words, a backend management server operable to perform the actions disclosed), gets his collateral back along with revenues accumulated to the point of burning. In addition, the LP gets permission to move its first cryptocurrency (e.g., Bitcoin). Accordingly, in an exemplary implementation, when the system discovers (by, for example the aid of watchers) that an LP moved its first cryptocurrency (e.g., Bitcoin) without permission, it automatically initiates a process at the end of which one cryptocurrency stable token (e.g., StableBTC token) is burned (in order to preserve the reserve ratio value of 1:1). In other words, the reserve value of 1 is maintained by making sure that the ratio between the value of the reserve (collateral) cryptocurrency pool in the second P2P blockchain network, and the value of the liquid pool in the first P2P blockchain network is one (1).

In an exemplary implementation, the step minting comprises: an active LP is obligated to keep first cryptocurrency (e.g., BTC) at the wallet associated with the first cryptocurrency it has declared (Hold) following the step of depositing the predetermined (requisite) amount of collateral second cryptocurrency (e.g., ETH). To verify possession of said first cryptocurrency (e.g., BTC), the LP will prove this by signing with its private key (or PK, in other words, proof of ownership, provided to the backend management server). From that moment on, the LP is expected to refrain from making any transactions in the first cryptocurrency (e.g., BTC) on Hold. In exchange for the proof of ownership of the first cryptocurrency (e.g., BTC) at a particular address, and the deposit of collateral as required, the LP receives the newly minted cryptocurrency stable token (e.g., StableBTC token).

Conversely, the step of burning comprises: a LP properly exits and burns a cryptocurrency stable token (e.g., StableBTC token). An LP that wants to exit for any reason, sends a cryptocurrency stable token (e.g., StableBTC token) to the system (in other words, the backend management server), receives the collateral of second cryptocurrency (e.g., ETH) and any accrued fees to that point, and can move the first cryptocurrency (e.g., BTC) without sanctions. The system operable to implement the methods disclosed, actively burns the cryptocurrency stable token (e.g., StableBTC token, Stable ETH token): If it is discovered / proven that the first cryptocurrency (e.g., BTC) declared by the LP does not exist or transferred without a permission, the collateral of a second cryptocurrency (e.g., ETH) of the LP is taken, and the cryptocurrency stable token (e.g., StableBTC token) is removed from circulation (e.g., through an auction) to maintain a quantitative adjustment between the cryptocurrency stable token (e.g., StableBTC token) on the first cryptocurrency blockchain (e.g., Ethereume blockchain) and first cryptocurrency (e.g., BTC) on the second cryptocurrency blockchain (e.g., Bitcoin blockchain) (see e.g., reserve ratio constant). In certain implementations, under extreme circumstances or market collapse, etc. a series of auctions are carried out that remove (e.g., burn) excess cryptocurrency stable token (e.g., StableBTC token) from circulation in exchange for the second cryptocurrency (e.g., ETH) accumulated in collateral of former LPs.

Accordingly and in another exemplary implementation, the step of preserving the reserve quality (operable to maintain the reserve ratio constant) of the second cryptocurrency stable token, in the systems, methods and computer-readable media for providing cryptocurrency liquidity for transactions in one blockchain with collateral cryptocurrency on another blockchain can comprise facilitating an auction to buy and/or sell the second cryptocurrency stable token among the plurality of network wallets, to determine the ratio between the value of the second cryptocurrency (e.g., ETH) and the first cryptocurrency (e.g., BTC).

In an exemplary implementation of the systems, methods and computer-readable media for providing cryptocurrency liquidity for transactions in one blockchain with collateral cryptocurrency on another blockchain, a collateral mechanism on the first cryptocurrency blockchain (e.g., Ethereum blockchain) and series of auctions are used as a substitute for locking value of the first cryptocurrency (e.g., BTC) by custodians or shared wallets of the second cryptocurrency blockchain (e.g., Bitcoin blockchain).

This raises the potential risk of an LP taking back the first cryptocurrency (e.g., BTC), which the LP (interchangeable with User) declared as holding and use it for other purposes (equivalent to theft in other systems). In an exemplary implementation, to mitigate that risk, the LP over-collateralizes the first cryptocurrency (e.g., BTC) it declares, that is, the value of the second cryptocurrency (e.g., ETH) the LP deposits is larger than the corresponding value of the first cryptocurrency (e.g., BTC) (at the time of deposit). If LP exits the system properly, they would buy a cryptocurrency stable token (e.g., StableBTC token) (to be returned to the system) and get their collateral second cryptocurrency (e.g., ETH) and accrued fees, whereas if the LP doesn’t exit properly, in an orderly fashion (i.e. it simply takes its own first cryptocurrency (e.g., BTC) and leaves) then there is no need to purchase the cryptocurrency stable token (e.g., StableBTC token) and consequently the LP won’t get back its collateral of the second cryptocurrency (e.g., ETH) and associated fees, which puts the LP at a loss due to the overcollateralization of the second cryptocurrency (e.g., ETH).

Accordingly, a rational LP will have a strong incentive to exit in an orderly fashion as long as the cost of buying the cryptocurrency stable token (e.g., StableBTC token) (to get back the collateral of the second cryptocurrency (e.g., ETH) and fees) is lower than the value of the deposit and fees. Otherwise, the LP will abandon the service by taking back the first cryptocurrency (e.g., BTC) held, or stay and wait for the surrounding circumstances to change until the system will force a sell of the collateral of the second cryptocurrency (e.g., ETH).

In an exemplary implementation, each LP, according to its risk profile, will be concerned when the value of the accrued fee is lower than the difference between the overcollateralization of the second cryptocurrency (e.g., ETH) and the value of the first cryptocurrency (e.g., BTC), due to the price increase of the first cryptocurrency (e.g., BTC) relative to the second cryptocurrency (e.g., ETH), because it means that from this point on, as the gap increases, the surplus collateral of the second cryptocurrency (e.g., ETH) erodes, leading to a net loss until the point where it is better for the LP not to exit properly and in an orderly fashion and abandon the (over) collateral of the second cryptocurrency (e.g., ETH). IN certain circumstances, LP that leaves abandoned collateral (which was previously worth the first cryptocurrency (e.g., BTC) and the surplus (in other words the agreed upon 1XX% of the second cryptocurrency (e.g., ETH)) and the accrued fees. In this case, the cryptocurrency stable token (e.g., StableBTC token) remains in circulation and doesn’t have a matching first cryptocurrency (e.g., BTC). To adjust the unbalanced quantities, the smart contract will perform an auction for the sale of the LP’s collateral to buy cryptocurrency stable token (e.g., StableBTC token) from the market to the bidder at the cheapest price (i.e. less of the second cryptocurrency (e.g., ETH) for one of the cryptocurrency stable token (e.g., StableBTC token)). Accordingly, the system purges the cryptocurrency stable token (e.g., StableBTC token) from circulation and the market adjusts (or rebalances) the amount of the cryptocurrency stable token (e.g., StableBTC token) to the amount of the first cryptocurrency (e.g., BTC) in Hold (essentially, in abeyance.

Accordingly, and in contrast to other systems that use a committee-based locks that prevent abandoning the system, the systems, methods and computer readable media disclosed herein protect itself by enforcing an LP to decide on abandoning or staying substantially before reaching a critical level (in other words, while the aforementioned gap between the value of the accrued fee and the value of the overcollateralization of the second cryptocurrency (e.g., ETH) is still positive).

In an exemplary implementation, to prevent a negative gap between the value of an LP’s collateral of the second cryptocurrency (e.g., ETH) and the first cryptocurrency (e.g., BTC), the system implementing the methods disclosed force a sell of the collateral of the second cryptocurrency (e.g., ETH) to equate the amount of the cryptocurrency stable token (e.g., StableBTC token) and the first cryptocurrency (e.g., BTC) on Hold. IN other words, in certain implementations, if at the time of adding a first cryptocurrency (e.g., BTC), the LP deposited a second cryptocurrency (e.g., ETH) in value of 1.xx (>1.00) of the first cryptocurrency (e.g., BTC), then during the operation of the system, it tracks the exchange rate between the first and second cryptocurrencies and when the value of the first cryptocurrency (e.g., BTC) is close enough to 1.xx of the second cryptocurrency (e.g., ETH) (e.g. when the ratio is 1.yy for some yy≤xx) the system automatically (in other words, without any action by any member of the network) forces an exit for this LP. This allows the system to buy a cryptocurrency stable token (e.g., StableBTC token) for up to 1.xx second cryptocurrency (e.g., ETH), and since the current exchange rate is 1.yy ≤1.xx this should be completed without a problem.

Therefore, the incentive for Liquidity Providers (LP) to hold the first cryptocurrency (e.g., BTC) and deposit collateral of the second cryptocurrency (e.g., ETH) at the 1.xx ratio is the fees that they get from transactions made with the cryptocurrency stable token (e.g., StableBTC token) on the the first cryptocurrency blockchain (e.g., Ethereum blockchain). The fees for transactions made with 1 cryptocurrency stable token (e.g., StableBTC token) over a period of time is the return on the net collateral deposit.

### EXAMPLE

Let the net collateral be 40% (i.e. 1.xx=1.40) and assume that each cryptocurrency stable token (e.g., StableBTC token) is transacted once a day over a period of one year. With 0.1% fee, these fees accumulates to 0.365 BTC that represents 91% yearly ROI on the net 0.4 BTC in deposit. The economic model of the service makes it irrational to move the held BTC instead of requesting to exit properly, because the protocol will obfuscate the collateral and the accumulated fees. The service can recover and handle this case and also support graceful and autonomous wind down in a catastrophic event. Since Ethereum is distributed and decentralized, there is no risk of manipulating ETH price to game the deposits and the service.

All ETH deposits are registered under the LPs PK in the smart contract for future release. When an LP wants to get the ETH deposit back, thet need to send one cryptocurrency stable token (e.g., StableBTC token) to the service and is allowed to free the Bitcoin it holds. Thus, LP has ETH invested (at t₀, 1xx% Bitcoin in value), they added value of one bitcoin to buy one StableBTC token to get back the collateral (originally 1xx% (x#0)) Bitcoin value). Note that the value of the deposit will vary over time.

Accordingly, in certain exemplary implementations, provided is a protocol to encourage LP participation on one hand and orderly exits on the other hand. It is likely that an LP that fears a loss of deposit or a decrease in its value will exit in an orderly manner and in such case gain/loss due to exchange rate changes. Each LP will calculate their tolerable loss after which the LP will not remain in the system. The economic balances are the accumulation of fees and the cost of entry into the service (by a deposit of 1.X of the cryptocurrency backing (BTC)) that will result in rationalization and avoidance of frequent panic driven actions. The accumulation of fees will not prevent LPs from exiting and returning in an orderly fashion in order to control the exposure to exchange rate on the collateral value and to realize profits from the accrued fees. Extreme cases of lacking BTC collateral, can be resolved by a parallel removal (burning) of e.g., StableBTC from circulation using an abandoned deposit and accrued fees. In cases of panic like a “run on the bank”, when everyone wants to get out of the service (in case of loss of trust in the service or sudden price crash), the mechanism guarantees repurchase of the entire StableBTC token with full or partial compensation from what is left behind from the deposit and fees.

Economically, the fact that the excess of the deposit of the second cryptocurrency (e.g., ETH) is smaller than one first cryptocurrency (e.g., BTC) causes the ROI for the LP to be higher, due to fees on the transactions of one first cryptocurrency (e.g., BTC). The premise is that there is a demand because of the desire to use a token that is truly pegged to first cryptocurrency (e.g., BTC), and there is a supply because of the incentives and risk levels known to the LP. On the supply side, there are ostensibly LPs willing to keep first cryptocurrency (e.g., BTC) locked (on Hold) and deposit collateral against it in the second cryptocurrency (e.g., ETH) to get a fee from cryptocurrency stable token (e.g., StableBTC token) transactions. And from the demand side, there are users of cryptocurrency stable token (e.g., StableBTC token) due to the guaranteed 1:1 correspondence between cryptocurrency stable token (e.g., StableBTC token) and first cryptocurrency (e.g., BTC) held, and therefore they will want to enjoy the benefits of cryptocurrency stable token (e.g., StableBTC token) pegged to the first cryptocurrency (e.g., BTC).

The term “module” is used herein to refer to software computer program code and/or any hardware or circuitry utilized to provide the functionality attributed to the module. Further, the term “module” or “component” can also refer to software objects or routines that execute on the computing system. The different components, modules, engines, and services described herein may be implemented as objects or processes that execute on the computing system (e.g., as separate f threads).

In addition, the computer program (software and/or firmware), can comprise program code means for carrying out the steps of the methods described herein, as well as a computer program product comprising program code means stored on a medium that can be read by a computer, such as a floppy disk, a hard disk, CD-ROM, DVD, USB memory stick, or a storage medium that can be accessed via a data network, such as the Internet or Intranet, when the computer program product is loaded in the main memory of a computer and is carried out by the computer.

The term “operable” as used herein means the system and/or the device and/or the program, or a certain element or step is fully functional, sized, adapted and calibrated, comprises elements for, and meets applicable operability requirements to perform a recited function when activated, coupled, implemented, actuated, effected, realized, or when an executable program is executed by at least one processor associated with the system and/or the device. In relation to systems and circuits, the term “operable” means the system and/or the circuit is fully functional and calibrated, comprises logic for, having the hardware and firmware necessary, as well as the circuitry for, and meets applicable operability requirements to perform a recited function when executed by at least one processor.

Memory device(s) as used in the methods described herein can be any of various types of non-volatile memory computer-readable media or storage computer-readable media (in other words, memory computer-readable media that do not lose the information thereon in the absence of power). The term “memory device” is intended to encompass an installation medium, e.g., a CD-ROM, floppy disks, or tape device or a non-volatile memory such as a magnetic media, e.g., a hard drive, optical storage, or ROM, EPROM, FLASH, etc. The memory device may comprise other types of memory as well, or combinations thereof. In addition, the memory medium may be located in a first computer in which the programs are executed, and/or may be located in a second different computer which connects to the first computer over a network, such as the Internet. In the latter instance, the second computer may further provide program instructions to the first computer for execution. The term “memory device” can also include two or more memory computer-readable media which may reside in different locations, e.g., in different computers that are connected over a network.

Further, CPM may be operably coupled to the various modules and components with appropriate circuitry. may also be used herein, the term(s) “operably coupled to”, “coupled to”, and/or “coupling” includes direct coupling between items and/or indirect coupling between items via an intervening item (e.g., an item includes, but is not limited to, a component, an element, a circuit, an engine, and/or a module) where, for indirect coupling, the intervening item does not modify the information of a signal but may adjust its current level, voltage level, and/or power level. As may further be used herein, inferred coupling (i.e., where one element is coupled to another element by inference) includes direct and indirect coupling between two items in the same manner as “coupled to”. As may even further be used herein, the term “operable to” or “operably coupled to” indicates that an item includes one or more of power connections, input(s), output(s), etc., to perform, when activated, one or more its corresponding functions and may further include inferred coupling to one or more other items. As may still further be used herein, the term “associated with”, includes direct and/or indirect coupling of separate items and/or one item being embedded within another item. Accordingly and in an embodiment, the central processing unit used in the systems, methods and computer-readable media disclosed herein can be in communication with CPM via management port, for example is a USB port, a Serial port, a RJ45 port, or a Fiber port.

Unless specifically stated otherwise, as apparent from the following discussions, it is appreciated that throughout the specification discussions utilizing terms such as “processing,” “loading,” “in communication,” “detecting,” “calculating,” “determining”, “analyzing,” or the like, refer to the action and/or processes of a computer or computing system, or similar electronic computing device, that manipulate and/or transform data represented as physical, such as a transistor architecture into other data similarly represented as physical and structural layers.

The term “comprising” and its derivatives, as used herein, are intended to be open ended terms that specify the presence of the stated features, elements, components, groups, integers, and/or steps, but do not exclude the presence of other unstated features, elements, components, groups, integers and/or steps. The foregoing also applies to words having similar meanings such as the terms, “including”, “having” and their derivatives.

All ranges disclosed herein are inclusive of the endpoints, and the endpoints are independently combinable with each other. “Combination” is inclusive of blends, mixtures, alloys, reaction products, and the like. The terms “a”, “an” and “the” herein do not denote a limitation of quantity, and are to be construed to cover both the singular and the plural, unless otherwise indicated herein or clearly contradicted by context. The suffix “(s)” as used herein is intended to include both the singular and the plural of the term that it modifies, thereby including one or more of that term (e.g., the stream(s) includes one or more stream). Reference throughout the specification to “one embodiment”, “another embodiment”, “an embodiment”, and so forth, when present, means that a particular element (e.g., feature, structure, and/or characteristic) described in connection with the embodiment is included in at least one embodiment described herein, and may or may not be present in other embodiments. In addition, it is to be understood that the described elements may be combined in any suitable manner in the various embodiments.

Accordingly and in an exemplary implementation, provided herein is a computerized method for collateralizing cryptocurrency in a first blockchain of a peer-to-peer distributed network, the method comprising: a first user via a first network node - depositing, with a first crypto wallet onto a predetermined address in the first blockchain, a predetermined value of a first cryptocurrency corresponding to the value of a second cryptocurrency stored in a second crypto wallet on a second blockchain; minting, at the first blockchain, a cryptocurrency stable token; and preserving a reserve value of the first cryptocurrency to equate the value of the second cryptocurrency and the minted stable token on the first blockchain, thereby collateralizing cryptocurrency in a first blockchain of a peer-to-peer distributed network, wherein (i) the first blockchain of the peer-to-peer distributed network is a permissionless blockchain (referring to public blockchains that allow anyone to participate in validating and mining transactions as well as using the system to buy, sell and trade assets) having a plurality of nodes, wherein (ii) the step of preserving the reserve quality of the second cryptocurrency stable token, comprises facilitating an auction to at least one of: buy and sell the cryptocurrency stable token among the plurality of network wallets (referring to wide area network-based account or software that allows people to buy, sell and trade cryptocurrency coins and tokens), to determine the ratio between the value of each of the second cryptocurrency and the first cryptocurrency, (iii) the first blockchain being Etherium blockchain (regardless of whether it is the “proof of work” blockchain, the “proof of stake” blockchain, or the merged blockchain) and the first cryptocurrency is Ether (ETH), (iv) the second blockchain is Bitcoin blockchain and the second cryptocurrency is bitcoin (BTC) and the cryptocurrency stable token minted on the first blockchain is a stable bitcoin (StableBTC) token, wherein (v) the first crypto wallet is associated with a smart contract implementable on the first blockchain of the P2P distributed network, wherein (vi) the step of facilitating the auctions among the plurality of network wallets is preceded by a step of excluding the first network node (the network node initiating the burning of the stable cryptocurrency coin) from the auction, wherein (vii) the ratio between the value of the first cryptocurrency and the value of the second cryptocurrency is greater than 1 and less than 2

$$2 < {r}_{r e s r v e r a t i o c o n s t a n t} = \frac{\text{value} \text{of} \text{the} \text{first} \text{cryptocurrency}}{\text{value} \text{of} \text{the} \text{second} \text{cryptocurrency}} > 1 ,$$

wherein (viii) the first user is a liquidity provider (LP) and wherein the liquidity provider accrues fees on transactions made using the minted cryptocurrency stable token, the method further comprising (ix) further comprising, upon determination by the first user to withdraw the collateral: Burn the minted cryptocurrency stable token; Withdraw the predetermined value of a first cryptocurrency from the first crypto wallet; and Retrieve the accrues fees on transactions made using the minted cryptocurrency stable token, and wherein (x) the step of burning the minted cryptocurrency stable token comprises returning the minted cryptocurrency stable token to a network administrator (in other words the backend management server) of the P2P network.

In another exemplary implementation, provided herein is a multi-user cryptocurrency host computer system comprising: At least one processor; a distributed register comprising: for each of the plurality of users, a plurality of cryptocurrency wallet addresses for a crypto wallet of each user; a non-transitory memory storage device, in communication with the at least one processor comprising: for each of a plurality of users of the host computer system, a plurality of cryptocurrency vault addresses for each user, the non-transitory memory storage device storing thereon a computer readable medium (CRM) with a set of executable instructions that when executed by the at least one processor control the processor to perform the steps of: depositing, by a first user with a first crypto wallet onto a predetermined address in the first distributed register, a predetermined value of a first cryptocurrency corresponding to the value of a second cryptocurrency stored in a second crypto wallet on a second distributed register, wherein the second distributed register is included with a second multi-user cryptocurrency host computer system having at least one processor and a non-transitory memory storage device, in communication with the at least one processor comprising: for each of a plurality of users of the second host computer system, a plurality of cryptocurrency vault addresses for at least the first user; minting a cryptocurrency stable token; and preserving a reserve value of the first cryptocurrency to equate the value of the second cryptocurrency and the minted stable token, wherein (xi) to preserve the reserve quality of the second cryptocurrency stable token the set of executable instructions in the CRM is further configured, when executed, to cause the at least one processor to perform the step of facilitating an auction to buy and/or sell the cryptocurrency stable token among the plurality of crypto wallets to determine the ratio between the values of the second cryptocurrency and the first cryptocurrency, wherein (xii) the ratio between the value of the first cryptocurrency and the value of the second cryptocurrency is greater than 1 and lesser than 2, wherein (xiii) the first user is a liquidity provider (LP) and wherein the liquidity provider accrues fees on transactions made using the minted cryptocurrency stable token, (xiv) whereupon determination by the first user to withdraw the collateral, the set of executable instructions in the CRM is further configured, when executed, to cause the at least one processor to: burn the minted cryptocurrency stable token; withdraw the predetermined value of a first cryptocurrency from the first crypto wallet; and retrieve the accrued fees on transactions made using the minted cryptocurrency stable token, and wherein (xv) to burn the minted cryptocurrency stable token the set of executable instructions in the CRM is further configured, when executed, to cause the at least one processor to perform the step of returning the minted cryptocurrency stable token to an administrator of the multi-user cryptocurrency host computer system.

Although the foregoing disclosure has been described in terms of some embodiments, other embodiments will be apparent to those of ordinary skill in the art from the disclosure herein. Moreover, the described embodiments have been presented by way of example only, and are not intended to limit the scope of the inventions. Indeed, the novel methods, programs, computer-readable media and systems described herein may be embodied in a variety of other forms without departing from the spirit thereof. Accordingly, other combinations, omissions, substitutions and modifications will be apparent to the skilled artisan in view of the disclosure herein.

1. A computerized method for collateralizing cryptocurrency in a first blockchain of a peer-to-peer distributed network, (Original) The method comprising:
a. a first user via a first network node - depositing, with a first crypto wallet onto a predetermined address in the first blockchain, a predetermined value of a first cryptocurrency corresponding to the value of a second cryptocurrency stored in a second crypto wallet on a second blockchain;
b. minting, at the first blockchain, a cryptocurrency stable token; and
c. preserving a reserve value of the first cryptocurrency to equate the value of the second cryptocurrency and the minted stable token on the first blockchain, thereby collateralizing cryptocurrency in a first blockchain of a peer-to-peer distributed network.

2. The method of claim 1, wherein the first blockchain of the peer-to-peer distributed network is a permissionless blockchain having a plurality of nodes.

3. The method of claim 2, wherein the step of preserving the reserve quality of the second cryptocurrency stable token comprises facilitating an auction to at least one of: buy and sell the cryptocurrency stable token among the plurality of network wallets to determine the ratio between the value of the second cryptocurrency and the first cryptocurrency.

4. The method of claim 3, wherein the first blockchain is Etherium blockchain and the first cryptocurrency is Ether (ETH).

5. The method of claim 4, wherein the second blockchain is Bitcoin blockchain and the second cryptocurrency is bitcoin (BTC) and the cryptocurrency stable token minted on the first blockchain is a stable bitcoin ( StableBTC) token.

6. The method of claim 3, wherein the first crypto wallet is associated with a smart contract implementable on the first blockchain of the peer-to-peer distributed network.

7. The method of claim 3, wherein the step of facilitating the auctions among the plurality of network wallets is preceded by a step of excluding the first network node from the auction.

8. The method of claim 1, wherein the ratio between the value of the first cryptocurrency and the value of the second cryptocurrency is greater than 1 and less than 2.

9. The method of claim 6, wherein the first user is a liquidity provider (LP) and wherein the liquidity provider accrues fees on transactions made using the minted cryptocurrency stable token.

10. The method of claim 9, further comprising, upon determination by the first user to withdraw the collateral:
a. Burn the minted cryptocurrency stable token;
b. Withdraw the predetermined value of a first cryptocurrency from the first crypto wallet; and
c. Retrieve the accrues fees on transactions made using the minted cryptocurrency stable token.

11. The method of claim 10, wherein the step of burning the minted cryptocurrency stable token comprises returning the minted cryptocurrency stable token to a network administrator of the peer-to-peer network.

12. A multi-user cryptocurrency host computer system comprising:
a. At least one processor;
b. a distributed register comprising: for each of the plurality of users, a plurality of cryptocurrency wallet addresses for a crypto wallet of each user;
c. a non-transitory memory storage device, in communication with the at least one processor comprising: for each of a plurality of users of the host computer system, a plurality of cryptocurrency vault addresses for each user, the non-transitory memory storage device storing thereon a computer readable medium (CRM) with a set of executable instructions that when executed by the at least one processor control the processor to perform the steps of:
i. depositing, by a first user with a first crypto wallet onto a predetermined address in the first distributed register, a predetermined value of a first cryptocurrency corresponding to the value of a second cryptocurrency stored in a second crypto wallet on a second distributed register, wherein the second distributed register is included with a second multi-user cryptocurrency host computer system having at least one processor and a non-transitory memory storage device, in communication with the at least one processor comprising: for each of a plurality of users of thesecond host computer system, a plurality of cryptocurrency vault addresses for at least the first user;
ii. minting a cryptocurrency stable token; and
iii. preserving a reserve value of the first cryptocurrency to equate the value of the second cryptocurrency and the minted stable token.

13. The system of claim 12, wherein to preserve the reserve quality of the second cryptocurrency stable token the set of executable instructions in the CRM is further configured, when executed, to cause the at least one processor to perform the step of facilitating an auction to buy and/or sell the cryptocurrency stable token among the plurality of crypto wallets to determine the ratio between the values of the second cryptocurrency and the first cryptocurrency.

14. The system of claim 13, wherein the ratio between the value of the first cryptocurrency and the value of the second cryptocurrency is greater than 1 and lesser than 2.

15. The system of claim 14, wherein the first user is a liquidity provider (LP) and wherein the liquidity provider accrues fees on transactions made using the minted cryptocurrency stable token.

16. The system of claim 15, whereupon determination by the first user to withdraw the collateral, the set of executable instructions in the CRM is further configured, when executed, to cause the at least one processor to:
a. burn the minted cryptocurrency stable token;
b. withdraw the predetermined value of a first cryptocurrency from the first crypto wallet; and
c. retrieve the accrued fees on transactions made using the minted cryptocurrency stable token.

17. The system of claim 16, wherein to burn the minted cryptocurrency stable token the set of executable instructions in the CRM is further configured, when executed, to cause the at least one processor to perform the step of returning the minted cryptocurrency stable token to an administrator of the multi-user cryptocurrency host computer system.
